(19) United States
(12) Patent Application Publication
(10) Pub. No.: US 2020/0386260 A1
(43) Pub. Date: Dec. 10, 2020

(54) Swivel Foot Screw Assembly

(71) Applicant: The Boeing Company, Chicago, IL (US)

(72) Inventors: Ricky L. Marchant, JR., Summerville, SC (US); Dustin Jeffry D'Angelo, Mount Pleasant, SC (US); Anthony E. Hunt, North Charleston, SC (US)

(21) Appl. No.: 16/433,489

(22) Filed: Jun. 6, 2019

(51) Int. Cl. F16B 35/06; F16C 11/06

(52) U.S. Cl. CPC F16B 35/06; F16B 2200/10; F16C 11/06

(57) ABSTRACT

A swivel foot screw assembly that includes an adjustment screw with an elongated shape that is mounted in a cap. A cap ring is mounted to the cap and maintains the adjustment screw secured to the cap. The adjustment screw is pivotally connected to the cap to be movable within a pivot envelope.

### TECHNOLOGICAL FIELD

The present disclosure relates generally to the field of mechanical assemblies and, more specifically, to swivel foot screw assemblies.

### BACKGROUND

Screw assemblies can include a threaded member that is movably attached to a contact member. The contact member can have an enlarged size that is wider than the threaded member to provide a base to make secure contact with a surface. In use, the screw assemblies are threaded onto a support member. The threaded member is rotated relative to the support member to position the contact member against a surface. The movable attachment of the contact member relative to the threaded member provides for the contact member to face towards and contact against the surface.

An issue with screw assemblies is that contact member may not be securely attached to the threaded member. During use, the contact member may detach from the threaded member. This can occur more frequently in environment in which the screw assemblies are exposed to vibrations or movement. It is difficult to design an attachment between the threaded member and contact member that provides for the relative movement, and still provides for secure attachment.

Manufacturing processes may be designed to provide for movably attaching the contact member to the threaded member. However, these may add cost to the screw assembly. Further, these designs may limit the application of the screw assemblies to more limited contexts. Still further, another issue with existing swivel foot screw assemblies is that existing designs require specialized manufacturing and tooling to swage and/or crimp the contact member in place. This makes it difficult to interchange parts of existing swivel foot assemblies (e.g., interchanging a contact member attached to the threaded member with a different contact member).

There is a need for improved swivel foot screw assemblies and methods for assembling swivel foot screw assemblies.

### SUMMARY

One aspect is directed to a swivel foot screw assembly that includes an adjustment screw with a ball on a first end, an adjustment head on a second end, and a threaded portion between the ball and the adjustment head. A cap includes a cavity to receive the ball of the adjustment screw. A cap ring is configured to connect to the cap and retain the ball within the cap.

In another aspect, the adjustment head has a width smaller than a width of the threaded portion.

In another aspect, the adjustment head includes one or more pairs of opposing flat surfaces with each of the pairs configured to be engaged by a tool.

In another aspect, the cap ring includes a body with a single-piece unitary construction and the body extends around a central opening and includes a cutout that extends through the body and is in communication with the opening.

In another aspect, the adjustment screw has a neck between the ball and the threaded portion with the neck positioned in the opening when the cap ring is connected to the cap.

In another aspect, the cap ring is threaded onto the cap and is positioned in the cavity.

In another aspect, the cap ring includes first and second members that are individually connected to the cap with each of the first and second members including a cut-out that align together and form a central opening that receives the adjustment screw when the first and second members are connected to the cap.

In another aspect, extensions extend outward from the first and second members and the cap includes slots that receive the extensions.

In another aspect, the cap ring includes a central opening that receives a neck of the adjustment screw with a width of the opening being greater than a width of the neck and less than a width of the ball.

In another aspect, the adjustment screw is pivotally connected to the cap with the ball being maintained within the cavity by the cap ring.

In another aspect, the cap ring includes a thickness measured between opposing first and second sides and the adjustment screw includes a neck with a length measured along a centerline of the adjustment screw and with the length being greater than the thickness.

In another aspect, the adjustment screw includes a neck that extends between the threaded portion and the ball with the cap ring positioned along the adjustment screw between the neck and the ball.

One aspect is directed to a swivel foot screw assembly that includes a cap with a cavity. An adjustment screw includes an elongated shape with a first end and a second end with the first end including a ball that fits within the cavity. The ball includes a rounded shaped that complements a concave shape of the cavity. A cap ring is removably connected to the cap to retain the ball within the cavity. The adjustment screw is pivotally attached to the cap and pivots about the ball.

In another aspect, the adjustment screw is pivotally attached to the cap and pivots within a pivot envelope that extends around the cap.

In another aspect, the second end of the adjustment screw includes one or more pairs of opposing flat sides configured to be engaged with a tool.

In another aspect, the cap ring includes a body with a first side and an opposing second side, a central opening that extends through the body, and a cutout that extends through the body and is in communication with the central opening with the cutout extending along a limited section of the body.

In another aspect, the body includes an outer edge with threads that engage with threads on the cap, and an inner edge that extends around the central opening.

In another aspect, the cutout is larger than a width of the adjustment screw for the adjustment screw to be inserted through the cutout and into the opening.

In another aspect, the cap ring includes first and second members that are each individually connected to the cap and that together form a central opening that receives the adjustment screw.

One aspect is directed to a method of assembling a swivel foot screw assembly. The method includes positioning a ball at a first end of an adjustment screw into a cavity in a cap, wherein a threaded portion and second end of the adjustment screw extend outward beyond the cap. The method includes positioning a cap ring around a neck of the adjustment screw with the neck extending along the adjustment screw between the ball and the threaded portion. The method includes attaching the cap ring to the cap while the neck is positioned within the cap ring. The method includes securing the ball in the cavity with the cap ring and with the ball being pivotally movable within the cavity.

In another aspect, positioning the cap ring around the neck of the adjustment screw includes inserting the neck of the adjustment screw through a cutout in the cap ring and aligning the neck within a central opening in the cap ring.

In another aspect, the method includes threading the cap ring onto the cap while the neck is positioned within the central opening.

In another aspect, positioning the cap ring around the neck of the adjustment screw includes positioning a first member around a first portion of the neck and a second member around a second portion of the neck.

In another aspect, the method includes attaching the first and second members to the cap with fasteners that are positioned away from the cavity.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of a swivel foot screw assembly.

FIG. 2 is a perspective view of a swivel foot screw assembly.

FIG. 3 is an exploded perspective view of the swivel foot screw assembly of FIG. 2.

FIG. 4 is a side view of an adjustment screw.

FIG. 5 is a perspective view of a cap.

FIG. 6 is a perspective view of a cap ring.

FIG. 7 is section view of the swivel foot screw assembly cut along line VII-VII of FIG. 2.

FIG. 8 is a schematic end view of a pivot envelope that extends around a swivel foot screw assembly.

FIG. 9 is a perspective view of a swivel foot screw assembly.

FIG. 10 is an exploded perspective view of the swivel foot screw assembly of FIG. 9.

FIG. 11 is a side view of an adjustment screw.

FIG. 12 is a perspective view of a cap.

FIG. 13 is a section view of the swivel foot screw assembly cut along line XIII-XIII of FIG. 9.

FIG. 14 is a section view of the swivel foot screw assembly cut along line XIV-XIV of FIG. 9.

FIG. 15 is a flowchart diagram of a method of assembling a swivel foot screw assembly.

FIG. 16 is a perspective view of a component that includes a swivel foot screw assembly.

FIGS. 17A-17D are perspective views of attachment and assembly of a swivel foot screw assembly on a component.

### DETAILED DESCRIPTION

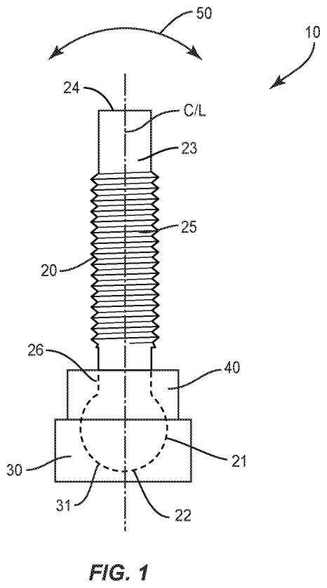

The present application is directed to a swivel foot screw assembly 10 as schematically illustrated in FIG. 1. The swivel foot screw assembly 10 includes an adjustment screw 20 with an elongated shape that is mounted in a cap 30. A cap ring 40 is mounted to the cap 30 and maintains the adjustment screw 20 secured to the cap 30. The adjustment screw 20 is pivotally connected to the cap 30 and can move within a pivot envelope 50. The adjustment screw 20 includes a ball 21 on a first end 22, and adjustment head 23 on a second end 24, and a threaded portion 25 between the ball 21 and the adjustment head 23. The cap 30 includes a cavity 31 to receive the ball 21 of the adjustment screw 20. The ball 21 includes a rounded shape that complements a concave shape of the cavity 31. The cap ring 40 is configured to connect to the cap 30 and retain the ball 21 within the cap 30.

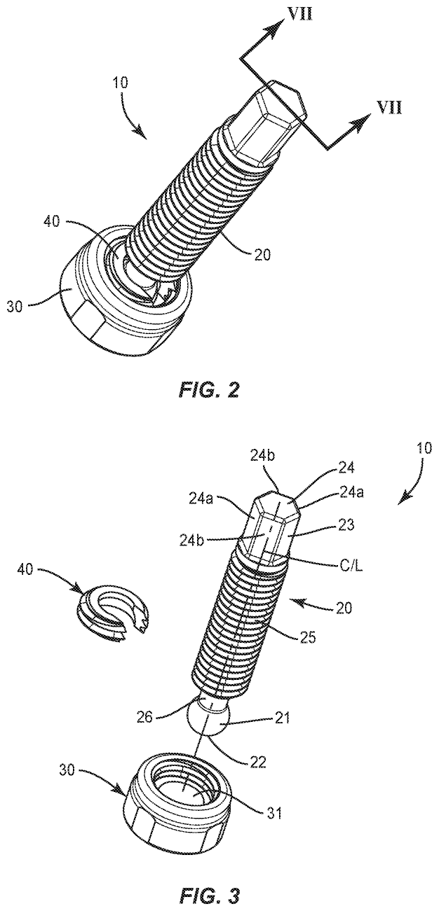

FIGS. 2 and 3 illustrate a swivel foot screw assembly 10 that includes an adjustment screw 20, cap 30, and a cap ring 40. The cap 30 is configured to receive an end of the adjustment screw 20. The cap ring 40 maintains the adjustment screw 20 secured to the cap 30 and allows for pivoting movement.

The adjustment screw 20 includes an elongated shape with a first end 22 and an opposing second end 24. The adjustment screw 20 includes a centerline C/L that extends along the length between the first end 22 and the second end 24. The first end 22 includes a ball 21 with a curved exterior shape. In one example, the ball 21 includes a spherical or substantially spherical shape. Other rounded shapes are possible as well. The surface of the ball 21 can be smooth to facilitate the pivoting contact with the cap 30.

The second end 24 includes an adjustment head 23 that has a polygonal sectional shape in a plane that is perpendicular to the centerline C/L. The adjustment head 23 includes one or more pairs of opposing flat sides configured to engage with a tool, as illustrated as 24a and 24b in FIG. 3. In one example, the adjustment head 23 includes a hexagonal sectional shape. Other examples include different sectional shapes.

The adjustment screw 20 includes a threaded portion 25 that extends along an intermediate length of the adjustment screw 20. The adjustment screw 20 also includes a narrow neck 26 that extends along the length between the ball 21 and the threaded portion 25. The neck 26 can include various lengths measured along the centerline C/L. In one example, the neck 26 includes a length that is greater than a thickness of the cap ring 40. The neck 26 can include various sectional shapes, such as but not limited to circular, rectangular, and oval.

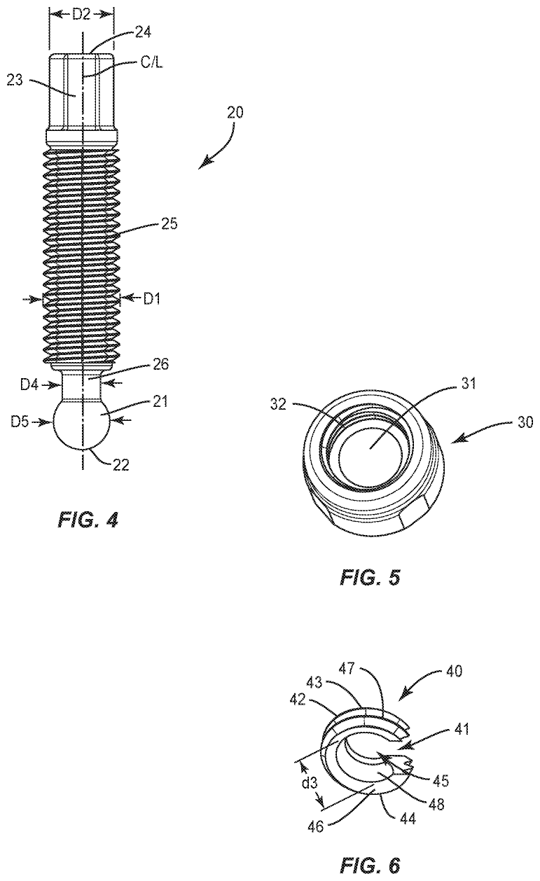

As illustrated in FIG. 4, the different sections of the adjustment screw 20 include different widths that are each measured perpendicular to the centerline C/L. The width D2 of the adjustment head 23 is smaller than the width D1 of the threaded portion 25. The width D5 of the ball 21 is larger than the width D4 of the neck 26. In an example, the width D5 of the ball 21 is smaller than the width D1 of the threaded portion 25 and the width D2 of the adjustment head 23. In one example, the ball 21 includes a constant radius throughout with the neck 26 extending outward from one side.

As illustrated in FIG. 5, the cap 30 includes a cavity 31 sized and shaped to receive the ball 21. In an example, the cavity 31 includes a spherical shape with a smooth surface that matches the smooth surface of the ball 21. In an example, this shape includes a concave shape. The smooth surfaces facilitate the pivoting movement of the ball 21 within the cavity 31. In one example, the cavity 31 includes a constant radius that is equal to the radius of the ball 21. Threads 32 are positioned along an upper portion of the cavity 31 to engage with the cap ring 40.

As illustrated in FIG. 6, the cap ring 40 includes a body 46 with an annular shape having a central opening 45. A cutout 41 extends through the body 46 and is in communication with the central opening 45. The cutout 41 is larger than the width D4 of the neck 26 for the neck 26 to be inserted through the cutout 41 and into the central opening 45.

The cap ring 40 includes an inner edge 48 that faces into the central opening 45 and an outer edge 47 that faces outwardly. Threads 42 are positioned on the outer edge 47 and configured to engage with the threads 32 on the cap 30. The cap ring 40 includes an inner diameter d3 measured across the central opening 45. The inner diameter d3 is greater than the width D4 of the neck 26 and less than the width D5 of the ball 21. This sizing provides for the neck 26 to be inserted through the cutout 41 and into the central opening 45, and then for the ball 21 to seat against the inner edge 48. In one example, the inner edge 48 includes a rounded shape that matches the rounded shape of the ball 21. As further illustrated in FIG. 6, the cap ring 40 includes opposing first and second sides 43, 44 and has a thickness that is measured between the sides 43, 44. In one example, the cap ring 40 includes a single-piece unitary construction.

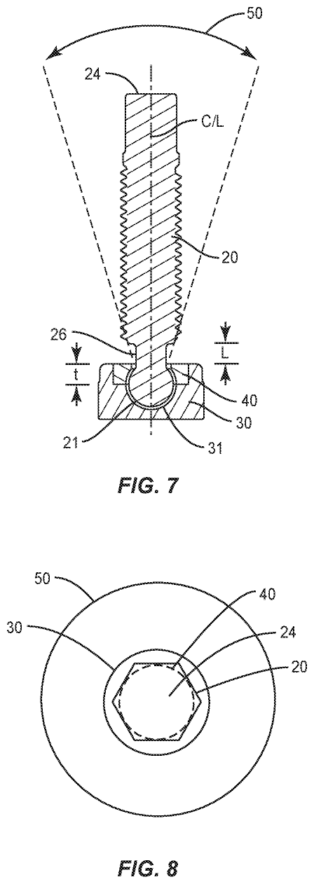

FIG. 7 illustrates the swivel foot screw assembly 10 with the ball 21 of the adjustment screw 20 positioned in the cavity 31 of the cap 30 and secured by the cap ring 40. The inner edge 48 of the cap ring 40 is positioned against the ball 21. This positioning provides for the adjustment screw 20 to pivot within a pivot envelope 50 relative to the cap 30 and cap ring 40. The extent of pivoting movement can vary. In one example as illustrated in FIG. 8, the adjustment screw 20 is movable with the centerline C/L at the second end 24 extends completely around the cap 30 and cap ring 40. In one example, the pivoting movement is limited by the neck 26 contacting against the inner edge 48 of the cap ring 40.

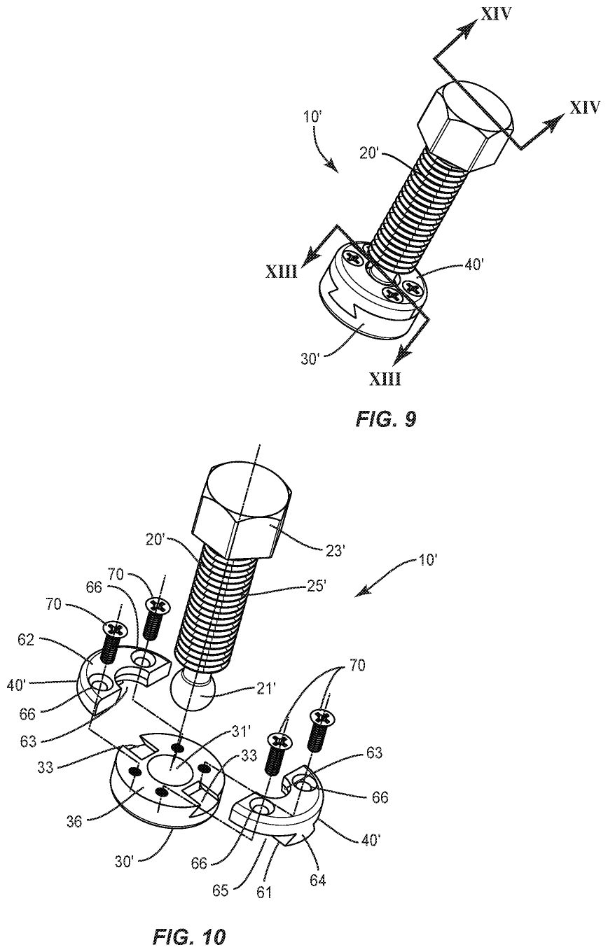

FIGS. 9 and 10 illustrate another example swivel foot screw assembly 10 that includes an adjustment screw 20, cap 30, and cap ring 40. As seen in FIGS. 9 and 10, swivel foot screw assembly 10′ includes an adjustment screw 20′, cap 30′, and cap ring 40′. The swivel foot screw assembly 10′ again provides for the adjustment screw 20′ to be pivotally connected to the cap 30′ by the cap ring 40′.

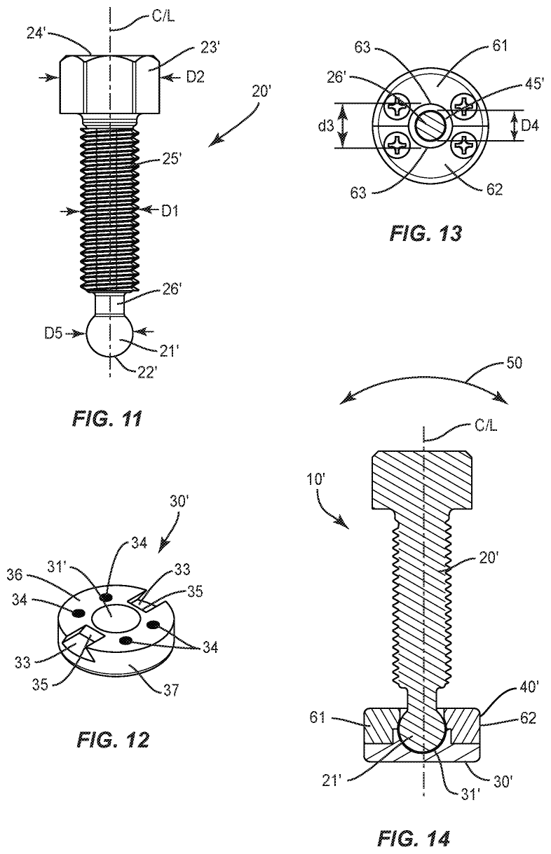

The adjustment screw 20′ includes an elongated shape with opposing first and second ends 22′, 24′ as illustrated in FIG. 11. The centerline C/L extends along the length and through the first and second ends 22′, 24′. The adjustment head 23′ includes one or more pairs of opposing flat surfaces that are configured to be engaged by a tool to rotate the adjustment screw 20′. One example includes the adjustment head 23′ with a polygonal sectional shape. In another example, the adjustment head 23′ includes other sectional shapes, such as but not limited to circular and oval. The width D2 of the adjustment head 23′ is larger than both the width D1 of the threaded portion 25′ and the width D5 of the ball 21′.

As illustrated in FIG. 12, the cap 30′ includes a cavity 31′ that receives the ball 21′. The complementary shapes provide for the ball 21′ to fit within and pivot in the cavity 31′. The cavity 31′ can include a constant diameter along a section that receives the ball 21′. The cavity 31′ can also include a smooth surface to facilitate the pivoting movement of the adjustment screw 20′.

Slots 33 in a top side 36 and are configured to receive the cap ring 40′. The slots 33 extend inward from an outer edge 37 towards the cavity 31′. The length of the slots 33 provide for the ends 35 to be radially spaced outward away from the cavity 31′. The slots 33 can include a dove-tailed shape with a lower section having a greater width than at the top side 36. Openings 34 are spaced about the top side 36 of the cap 30′.

As illustrated in FIG. 10, the cap ring 40′ is constructed from a first member 61 and a second member 62. Each of the first and second members 61, 62 include a rounded shape with a cut-out 63 along an inner edge. Each of the first and second members 61, 62 is sized to extend around a portion of the adjustment screw 20′. Each of the first and second members 61, 62 includes an extension 64 that extends outward from a bottom 65 and is sized and shaped to engage with one of the slots 33 on the cap 30′. In an example, the extensions 64 include a dove-tail shape that tapers and is sized and shape to complement the dovetail shape of the slots 33 and provide for the extensions 64 to be inserted into the slots 33 from the outer edge 37 of the cap 30′ and then slid inward towards the cavity 31′. In another example, the shapes of the extensions 64 and slots 33 provides for the first and second members 61, 62 to be inserted downward onto the top side 36 of the cap 30′.

One or more openings 66 extend through each of the first and second members 61, 62. The openings 66 are positioned to align with the openings 34 on the cap 30′ when the members 61, 62 of cap ring 40′ are positioned on the cap 30′. One or more fasteners 70 can extend through the aligned openings 34, 66 to secure each of the members 61, 62 to the cap 30′. The fasteners 70 are positioned away from the cavity 31′ to not interfere with the pivoting movement of the adjustment screw 20′.

As illustrated in FIG. 13, the first and second members 61, 62 have an annular shape when attached to the cap 30′. In one example as illustrated in FIG. 13, the first and second members 61, 62 contact together. In another example, relatively small gaps are formed between the first and second members 61, 62 when attached to the cap 30′. The cut-outs 63 of the first and second members 61, 62 align together and form a central opening 45′. The opening 45′ is sized to extend around the neck 26′ of the adjustment screw 20′. The opening 45′ includes an inner width d3 that is larger than the width D4 of the neck 26′. In one example, each of the first and second members 61, 62 includes an identical or substantially identical shape and size. In another example, the first and second members 61, 62 include different shapes and/or sizes.

As illustrated in FIG. 14, the cap ring 40′ is attached to and secures the ball 21′ of the adjustment screw 20′ in the cavity 31′. The adjustment screw 20′ can pivot about the ball 21′ within a pivot envelope 50. The tops of the first and second members 61, 62 that form the cap ring 40′ are flat when attached to the cap 30′.

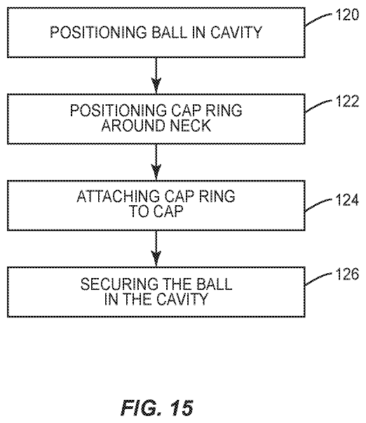

FIG. 15 includes a method of assembling a swivel foot screw assembly 10. The method includes positioning a ball 21 at a first end 22 of an adjustment screw 20 into a cavity 31 in a cap 30 (block 120). This also positions a threaded portion 25 and a second end 24 of the adjustment screw 20 outward beyond the cap 30. A cap ring 40 is positioned around the neck 26 of the adjustment screw 20 (block 122). In one example, this includes inserting a neck 26 of the adjustment screw 20 through a cutout 41 in the cap ring 40 and into a central opening 45 in the cap ring 40. The cap ring 40 can be positioned around the neck 26 before or after the ball 21 is positioned in the cavity 31. In another example, a first member 61 is positioned around a first portion of the neck 26 and a second member 62 is positioned around a second portion of the neck 26.

The cap ring 40 is attached to the cap 30 while the neck 26 is positioned within the cap ring 40 (block 124). In one example, this can include threading the cap ring 40 onto the cap 30. In another example, this includes inserting fasteners 70 and attaching each of the first and second members 61, 62 to the cap 30. The cap ring 40 secures the ball 21 in the cavity 31 with the ball 21 being pivotally movable within the cavity 31 (block 126).

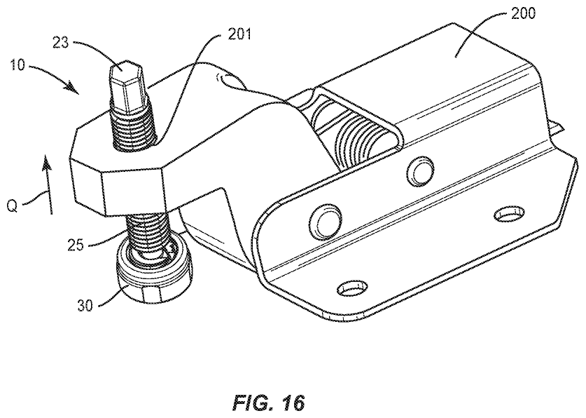

The swivel foot screw assembly 10 can be used with a variety of different components 200. FIG. 16 illustrates a component 200 as a latch that includes an opening 201 that receives the swivel foot screw assembly 10. In one example, the width of the opening 201 is sized to engage with the threaded portion 25. During assembly, the swivel foot screw assembly 10 is inserted in the direction of arrow Q. The adjustment head 23 is narrower than the opening 201 and can be inserted opening 201. The threaded portion 25 engages with the opening 201 which is also threaded. The cap 30 is positioned to contact against various surfaces to apply a force. The adjustability of the cap 30 relative to the adjustment screw 20 accommodates contact of the cap 30 against the surface.

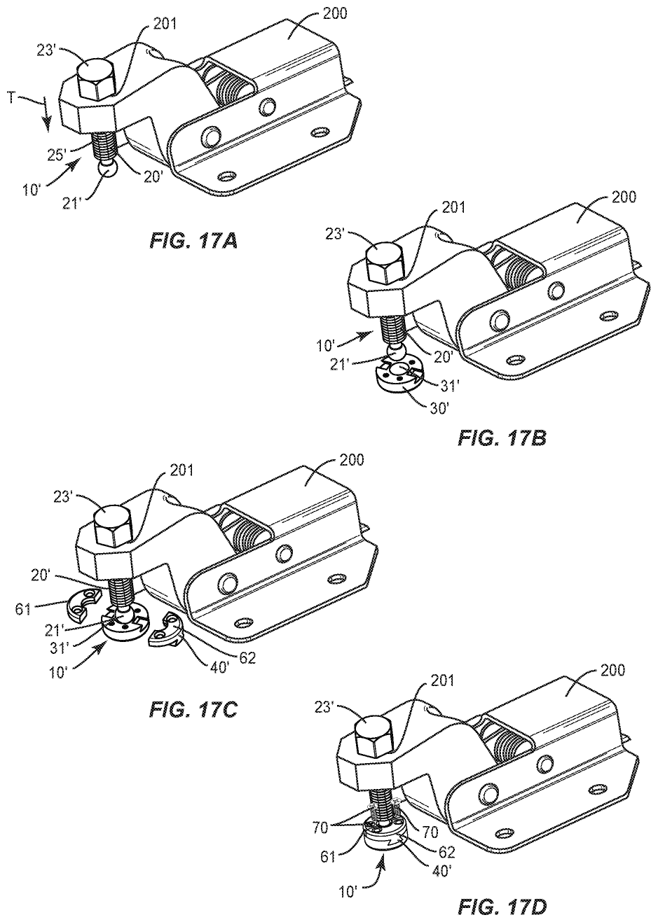

FIGS. 17A-17D illustrate a swivel foot screw assembly 10 being attached to a component 200. As illustrated in FIG. 17A, the adjustment head 23′ of the adjustment screw 20′ is wider than the opening 201 in the component 200. Therefore, the adjustment screw 20′ is inserted into the opening 201 prior to assembly of the swivel foot screw assembly 10′. As illustrated in FIG. 17A, the adjustment screw 20′ is inserted in the direction of arrow T with the ball 21′ and threaded portion 25′ being inserted through the opening 201. This positions the adjustment head 23′ on an opposing side of the opening 201.

As illustrated in FIG. 17B, the cap 30′ is then aligned with the adjustment screw 20′. This includes positioning the ball 21′ within the cavity 31′. As illustrated in FIG. 17C, first and second members 61, 62 are then inserted to form a cap ring 40′ that maintains the ball 21′ positioned within the cavity 31′.

As illustrated in FIG. 17D, fasteners 70 attach the first and second members 61, 62 to the cap 30′. The first and second members 61, 62 form the cap ring 40′ that secures the ball 21′ within the cavity 31′. Further, the cap 30′ and cap ring 40′ can rotate relative to the adjustment screw 20′ to provide for contact with surfaces at various angular positions relative to the component 200. An example benefit of swivel foot screw assembly 10′ is that during use (e.g., during flight) the adjustment screw 20′ is unable to separate from the component 200, since the cap 30′ and adjustment head 23′ prevent the adjustment screw 20′ from being able to thread itself out through opening 201.

The swivel foot screw assembly 10 can be used with a variety of different components 200. Examples include but are not limited to door latches, door locks, and support members.

In one example, the swivel foot screw assembly 10 is used with a component 200 on a variety of different vehicles. Vehicles can include but are not limited to manned aircraft, unmanned aircraft, manned spacecraft, unmanned spacecraft, manned rotorcraft, unmanned rotorcraft, satellites, rockets, missiles, manned terrestrial vehicles, unmanned terrestrial vehicles, manned surface water borne vehicles, unmanned surface water borne vehicles, manned sub-surface water borne vehicles, unmanned sub-surface water borne vehicles, and combinations thereof.

An example benefit of swivel foot screw assembly 10 is that the swivel foot screw assembly can be assembled without manufacturing and tooling to swage and/or crimp the contact member in place. Another example benefit is that the swivel foot screw assembly 10 allows for interchanging of parts of the swivel foot screw assembly. For instance, since the cap 30 and cap ring 40 can be separated from the adjustment screw 20, the swivel foot screw assembly 10 allows for interchanging different adjustment screws. As another example, the swivel foot screw assembly 10 allows for attaching different sized caps to the adjustment screw.

By the term “about” or “substantial” and “substantially” or “approximately,” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

The present invention may be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A swivel foot screw assembly comprising:
an adjustment screw comprising a ball on a first end, an adjustment head on a second end, and a threaded portion between the ball and the adjustment head;
a cap comprising a cavity to receive the ball of the adjustment screw; and
a cap ring configured to connect to the cap and retain the ball within the cap.

2. The swivel foot screw assembly of claim 1, wherein the adjustment head has a first width that is different than a second width of the threaded portion.

3. The swivel foot screw assembly of claim 1, wherein the adjustment head comprises one or more pairs of opposing flat surfaces with each of the pairs of opposing flat surfaces configured to be engaged by a tool.

4. The swivel foot screw assembly of claim 1, wherein the cap ring comprises a body with a single-piece unitary construction, the body extends around a central opening and includes a cutout that extends through the body and is in communication with the central opening.

5. The swivel foot screw assembly of claim 4, wherein the adjustment screw has a neck between the ball and the threaded portion with the neck positioned in the central opening when the cap ring is connected to the cap.

6. The swivel foot screw assembly of claim 4, wherein the cap ring is threaded onto the cap and is positioned in the cavity.

7. The swivel foot screw assembly of claim 1, wherein the cap ring comprises first and second members that are individually connected to the cap, each of the first and second members comprise a cut-out that align together and form a central opening that receives the adjustment screw when the first and second members are connected to the cap.

8. The swivel foot screw assembly of claim 7, further comprising extensions that extend outward from the first and second members, and the cap comprises slots that receive the extensions.

9. The swivel foot screw assembly of claim 1, wherein the cap ring comprises a central opening that receives a neck of the adjustment screw, a width of the central opening is greater than a width of the neck and less than a width of the ball.

10. The swivel foot screw assembly of claim 1, wherein the adjustment screw is pivotally connected to the cap with the ball being maintained within the cavity by the cap ring.

11. The swivel foot screw assembly of claim 1, wherein the cap ring comprises a thickness measured between opposing first and second sides and the adjustment screw comprises a neck with a length measured along a centerline of the adjustment screw, the length being greater than the thickness.

12. The swivel foot screw assembly of claim 1, wherein the adjustment screw comprises a neck that extends between the threaded portion and the ball, the cap ring is positioned along the adjustment screw between the neck and the ball.

13. A swivel foot screw assembly comprising:
a cap comprising a cavity;
an adjustment screw comprising an elongated shape with a first end and a second end, the first end comprising a ball that fits within the cavity, the ball comprising a rounded shape that complements a concave shape of the cavity; and
a cap ring that is removably connected to the cap to retain the ball within the cavity;
wherein the adjustment screw is pivotally attached to the cap and pivots about the ball.

14. The swivel foot screw assembly of claim 13, wherein the adjustment screw is pivotally attached to the cap and pivots within a pivot envelope that extends around the cap.

15. The swivel foot screw assembly of claim 13, wherein the second end of the adjustment screw comprises one or more pairs of opposing flat sides configured to be engaged with a tool.

16. The swivel foot screw assembly of claim 13, wherein the cap ring comprises:
a body with a first side and an opposing second side;
a central opening that extends through the body; and
a cutout that extends through the body and is in communication with the central opening, the cutout extending along a limited section of the body.

17. The swivel foot screw assembly of claim 16, wherein the body comprises:
an outer edge with threads that engage with threads on the cap; and
an inner edge that extends around the central opening.

18. The swivel foot screw assembly of claim 17, wherein the cutout is larger than a width of the adjustment screw for the adjustment screw to be inserted through the cutout and into the central opening.

19. The swivel foot screw assembly of claim 13, wherein the cap ring comprises first and second members that are each individually connected to the cap and that together form a central opening that receives the adjustment screw.

20. A method of assembling a swivel foot screw assembly, the method comprising:
positioning a ball at a first end of an adjustment screw into a cavity in a cap, wherein a threaded portion and second end of the adjustment screw extend outward beyond the cap;
positioning a cap ring around a neck of the adjustment screw, the neck extends along the adjustment screw between the ball and the threaded portion;
attaching the cap ring to the cap while the neck is positioned within the cap ring; and
securing the ball in the cavity with the cap ring with the ball being pivotally movable within the cavity.

21. The method of claim 20, wherein positioning the cap ring around the neck of the adjustment screw comprises inserting the neck of the adjustment screw through a cutout in the cap ring and aligning the neck within a central opening in the cap ring.

22. The method of claim 21, further comprising threading the cap ring onto the cap while the neck is positioned within the central opening.

23. The method of claim 20, wherein positioning the cap ring around the neck of the adjustment screw comprises positioning a first member around a first portion of the neck and a second member around a second portion of the neck.

24. The method of claim 23, further comprising attaching the first and second members to the cap with fasteners that are positioned away from the cavity.
